(19) United States
(12) Patent Application Publication
(10) Pub. No.: US 2013/0308677 A1
(43) Pub. Date: Nov. 21, 2013

(54) TEMPERATURE MEASURING APPARATUS AND METHOD FOR A FLUID IN A MICRO CHANNEL

(71) Applicant: Eishi Igata, Utsunomiya-shi (JP)

(72) Inventor: Eishi Igata, Utsunomiya-shi (JP)

(73) Assignee: CANON KABUSHIKI KAISHA, Tokyo (JP)

(21) Appl. No.: 13/991,173

(22) PCT Filed: Dec. 8, 2011
(86) PCT No.: PCT/JP2011/078978

§ 371 Date: Jul. 24, 2013

(30) Foreign Application Priority Data
Dec. 20, 2010 (JP) 2010-283382

(51) Int. Cl. G01K 13/02

(52) U.S. Cl. CPC G01K 13/02
USPC 374/135

(57) ABSTRACT

Provided is a temperature measuring apparatus for a fluid in a micro channel, having a micro channel through which a fluid is allowed to flow; a unit for measuring an amount of flow of the fluid; a unit for measuring pressures at an inlet and an outlet of the micro channel; and a unit for calculating a viscosity of the fluid and a temperature in the micro channel from a difference between the pressures.

### TECHNICAL FIELD

The present invention relates to an apparatus and method for measuring a temperature of a fluid contained in a micro channel.

### BACKGROUND ART

Obtaining desired information such as temperature, concentration, and composition in order to confirm a progress and a result of chemical and biochemical reactions is a basic matter in analytical chemistry and industrial chemistry, and various apparatus and sensors for obtaining those pieces of information have been invented. The concept called micro total analysis system (μ-TAS) or lab-on-a-chip is being established, in which the above-mentioned apparatus and sensors are miniaturized using precision processing and a semiconductor producing device, and all the steps until obtaining desired information are realized on a micro device. This concept aims to obtain a desired concentration of a component contained in a final sample, a desired chemical compound, and the like through the steps such as sample purification and chemical reaction by allowing a collected unpurified sample or a raw material substance to pass through a channel or a minute space formed in a micro device. Further, the micro device that performs such analysis and reaction necessarily deals with a small amount of solution and gas, and hence is called a microfluidic device in most cases.

Compared with desk-top size analytical equipment in the related art, the use of a microfluidic device decreases the capacity of a fluid contained in a device, and therefore a reaction time is expected to be shortened due to the reduction in a required reagent amount and the minimization of an analyte. As the advantages of the microfluidic device are being recognized, the technical development regarding the μ-TAS is proceeding.

On the other hand, it is also recognized that matters which have not been problems in the desk-top size analytical equipment become new technical problems in the microfluidic device. One of the problems is the measurement of a temperature of a fluid flowing through the micro channel. The temperature information is an important parameter regarding whether appropriate enzyme reaction or chemical reaction has been effected, and the same also applies to a reaction performed in the microfluidic device. However, although the desk-top size analytical equipment can measure the temperature easily by bringing a thermocouple into contact with a fluid, it is difficult to insert a thermocouple in a micro channel due to the small dimensions of the channel, which makes it difficult to obtain temperature information.

Regarding the measurement of a temperature in a micro channel, there is disclosed a method of measuring a temperature by placing a metal thin film made of chromel or the like serving as a thermocouple in a channel (see Patent Literature 1). Further, as a method of measuring a temperature without a contact with a fluid, there is known a measuring method using temperature dependency of fluorescence intensity with respect to a fluid containing a fluorescent dye (see Non Patent Literature 1). In general, when a fluorescent dye increases in temperature, quantum efficiency decreases, which also decreases fluorescence intensity. Therefore, by measuring fluorescence intensity at a particular temperature, the temperature can be predicted.

Further, as a temperature measuring method using chemical reaction at a particular temperature, there is disclosed a method using a melting point of a gene (see Patent Literature 2). By measuring extinction of an intercalator fluorescent dye in a fluid containing a gene whose melting point is previously set, the temperature of the fluid can be specified. Further, there is disclosed a method using the phase change of a substance (see Patent Literature 3). According to this method, the temperature is measured using such a property that a substance changes from a solid phase to a liquid phase at a particular temperature while keeping the temperature. The melting point of a gene and the phase change are effective for confirming a particular temperature because the structure of a substance changes rapidly at a set temperature.

### CITATION LIST

### Patent Literature

PTL 1: Japanese Patent Application Laid-Open No. 2006-130599 (paragraph 6, FIG. 1)

PTL 2: US 2007/0026421 (paragraph 2, FIG. 4a)

PTL 3: U.S. Pat. No. 6,974,660 (paragraph 2, FIG. 1)

### Non Patent Literature

NPL 1: David Ross, Michael Gaitan and Laurie E. Locascio, “Temperature Measurement in Microfluidic Systems Using a Temperature-Dependent Fluorescent Dye,” Analytical Chemistry, 2001, Vol. 73, No. 17, pp 4117-4123

### SUMMARY OF INVENTION

### Technical Problems

The above-mentioned method of placing a metal thin film in a micro channel has a problem in that a production process is complicated and a special production device is required. Further, the temperature measuring method using fluorescence intensity of a fluorescent dye has a problem that optical equipment is required for observing fluorescence intensity precisely. Further, although the temperature measuring methods using the melting point of a gene and the phase change are effective for confirming a particular temperature at which a change occurs, those methods are unsuitable for measuring an arbitrary temperature. Further, those methods have a problem that it takes time and labor for preparing a measurement sample, such as the necessity of a chemical substance with a gene or a composition adjusted.

The present invention has been made in view of the background art, and its object is to provide a temperature measuring method of measuring an arbitrary temperature in a micro channel without using a complicated production process, without requiring expensive optical equipment, and without taking time and labor for preparing a measurement sample.

### Solution to Problems

A temperature measuring apparatus for a fluid in a micro channel which solves the above-mentioned problems includes: a micro channel through which a fluid is allowed to flow; a unit for measuring an amount of flow of the fluid; a unit for measuring pressures at an inlet and an outlet of the micro channel; and a unit for calculating a viscosity of the fluid and a temperature in the micro channel from a difference between the pressures.

A temperature measuring method for a fluid in a micro channel which solves the above-mentioned problems includes: measuring an amount of flow of a fluid flowing through the micro channel; measuring pressures at an inlet and an outlet of the micro channel; calculating a viscosity of the fluid; and calculating a temperature in the micro channel.

### Advantageous Effects of Invention

The present invention presents a measuring method of calculating a temperature in a micro channel, based on the viscosity of a fluid flowing through the microfluid. The present invention has an effect of simplifying the production process of a microfluidic device without requiring forming a structure in the micro channel.

Further, the present invention has an effect of requiring no expensive optical equipment for detecting light emitted from a liquid for calculating a viscosity.

Further, the present invention has an effect of being capable of easily measuring the temperature without requiring separately preparing a fluid for measurement because the present invention can use a fluid to be measured.

Further features of the present invention will become apparent from the following description of exemplary embodiments with reference to the attached drawings.

### BRIEF DESCRIPTION OF DRAWINGS

FIG. 1 is a conceptual view illustrating a temperature measuring apparatus of the present invention.

FIG. 2 is a conceptual diagram illustrating a temperature-viscosity correlation in a fluid.

FIG. 3 is a conceptual diagram illustrating a temperature-viscosity correlation in a fluid.

FIG. 4 is a conceptual view illustrating one embodiment using the temperature measuring apparatus of the present invention.

FIG. 5 is a conceptual view illustrating one embodiment for temperature distribution measurement of a fluid device in the temperature measuring apparatus of the present invention.

FIG. 6 is a conceptual view illustrating one embodiment of measuring a temperature in a microfluidic device in the temperature measuring apparatus of the present invention.

### DESCRIPTION OF EMBODIMENTS

The following is a detailed description of the present invention.

A temperature measuring apparatus according to the present invention includes: a micro channel through which a fluid is allowed to flow; a unit for measuring an amount of flow of the fluid; a unit for measuring pressures at an inlet and an outlet of the micro channel; and a unit for calculating a viscosity of the fluid and a temperature in the micro channel from a difference between the pressures.

It is preferred that the fluid be previously measured for a temperature-viscosity correlation and that the temperature-viscosity correlation is determined in one-to-one correspondence.

It is preferred that the unit for measuring the amount of flow be one of a syringe, a syringe pump, and a flow sensor placed in inside or outside of the micro channel.

It is preferred that the unit for measuring the pressures be a pressure sensor placed in inside or outside of the micro channel.

It is preferred that the inlet and the outlet be ports that are placed on a surface of a microfluidic device including the micro channel and communicate with the micro channel, and that a particular inlet and a particular output correspond to each other in one-to-one correspondence.

It is preferred that the micro channel include multiple injection channels for respectively injecting multiple fluids that are incompatible with one another, and be a channel in which the multiple injection channels are merged at one point on a downstream side of an injection point.

A temperature measuring method according to the present invention includes: measuring an amount of flow of a fluid flowing through a micro channel; measuring pressures at an inlet and an outlet of the micro channel; calculating a viscosity of the fluid; and calculating a temperature in the micro channel.

It is preferred that a part of the micro channel contains a liquid droplet incompatible with the fluid.

It is preferred that, in the micro channel, multiple fluids incompatible with one another form laminar flows respectively, and that a temperature of at least one of the laminar flows be measured.

The present invention relates to a method of measuring a temperature in a micro channel in contact or no contact with a fluid. The micro channel generally shows a Reynolds number of about 2,000 or less, and hence the flow in the micro channel can be considered as a laminar flow. When the flow of a fluid is present in a capillary channel with a radius of r having a certain pressure difference, the pressure difference complies with the Hagen-Poiseuille equation: ΔP=8ηLV/πr⁴, where ΔP represents a pressure difference, η represents a viscosity of a fluid, L represents a length of a channel, and V represents a volume of flow. Generally, the channel length L is known or can be measured easily, and the volume of flow V can be measured from the amount of a fluid injected into a channel or discharged therefrom. Further, by measuring the pressures of an injection port and a discharge port of a micro channel, ΔP can be obtained. Thus, the viscosity of a fluid passing through a channel can be calculated from the above-mentioned equation.

Next, as properties of a fluid, it is known that the viscosity depends upon temperature. In general, the viscosity of a liquid decreases with increasing temperature, and the viscosity of a gas increases with increasing temperature. Here, the reaction in a micro channel in a biological application is mostly limited to 0° C. to 100° C. Therefore, the viscosity of a liquid decreases uniformly in this temperature range, and hence the relationship between the viscosity and the temperature is determined in one-to-one correspondence.

Further, the temperature-viscosity correlation of oil complies with the following Walther-ASTM equation: log₁₀log₁₀(υ+0.7)=n·m log₁₀ T, where T represents an absolute temperature, υ represents a kinematic viscosity, and m and n are coefficients that differ for each substance. The kinematic viscosity is obtained by dividing the viscosity η by a density. That is, if the viscosity is known regarding particular oil, the temperature can be calculated. The viscosity-temperature characteristics of a large number of kinds of commercially available oils are known in most cases. In particular, the viscosities with respect to temperatures of 40° C. and 100° C. are used as typical characteristic values, and hence the coefficients m and n are obtained from the two temperatures.

Further, the viscosity at a particular temperature can be measured using a viscometer even with respect to a fluid other than oil, and the temperature-viscosity correlation of a fluid to be measured can be obtained previously. Thus, if the viscosity is known regarding a particular fluid, the temperature thereof can be obtained.

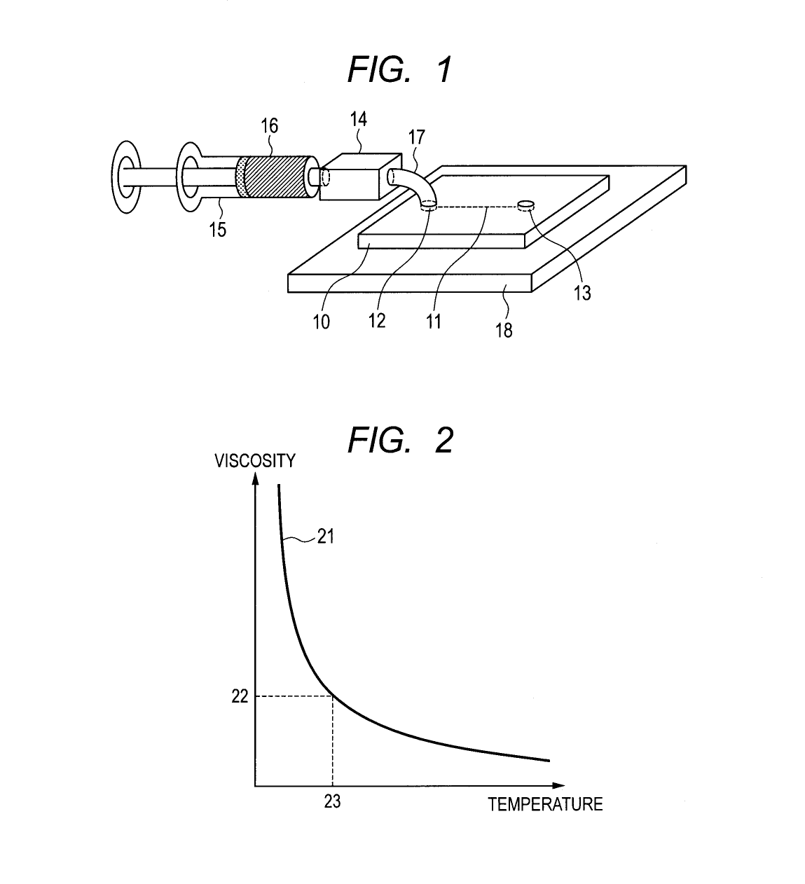

According to the present invention, by using the above-mentioned principle, a fluid having a known temperature-viscosity correlation is injected into a micro channel and the viscosity is calculated to measure the temperature in the micro channel. FIG. 1 is a conceptual view illustrating one embodiment of the temperature measuring apparatus of the present invention. Hereinafter, the temperature measuring apparatus is described in detail with reference to FIG. 1.

A microfluidic device 10 includes a micro channel 11, and the micro channel 11 communicates with the outside through ports 12 and 13. The port 12 is connected to a pressure meter 14 through a tube 17. Further, a syringe 15 contains a fluid 16 and is connected to the pressure meter 14. A temperature adjusting device 18 positioned below the microfluidic device 10 creates an arbitrary temperature when the fluid 16 is injected into the micro channel 11.

The material for the microfluidic device 10 is not particularly required to be limited to glass, ceramics, plastic, semiconductor, or a hybrid thereof. However, such material that absorbs the fluid 16 or reacts with the fluid 16 is inappropriate. Further, in the case where the microfluidic device 10 is set in a special environment such as a high-temperature environment, it is necessary to consider the durability to such a special environment.

It is desired that the micro channel 11 have such dimensions that the Reynolds number is about 2,000 or less. The ports 12 and 13 are formed by opening holes with a drill during processing, and hence the ports 12 and 13 have circular shapes in many cases. However, the dimensions and shape thereof are not particularly limited. The tube 17 only needs to be fixed to the port 12 by an arbitrary method such as an adhesive or adhesive tape. Further, regarding the connection to the pressure meter 14, the tube 17 may be fixed to the pressure meter 14 with a screw or may be fitted in an outlet portion of the pressure meter 14. Thus, the fixing method is not limited.

The pressure meter 14 is connected to the microfluidic device 10 through the tube 17 in FIG. 1. However, the outlet of the pressure meter 14 may be directly connected to the microfluidic device 10. In particular, in the case where a pressure sensor is produced with a microfluidic device 10, the pressure meter 14 may be positioned at an inlet of the micro channel 11.

The syringe 15 supplies the fluid 16 to the micro channel 11 through the pressure meter 14, and it is preferred that the syringe 15 be provided with a scale capable of measuring the injection amount. If the volume of flow is required at higher precision, the amount of flow may be measured with a syringe pump or a flow sensor.

The temperature adjusting device 18 may be any device capable of creating an arbitrary temperature, and examples thereof include a hot plate and a Peltier device. Further, a metal layer may be formed on the bottom surface of the microfluidic device 10, and the temperature may be set by allowing a current to flow through the metal layer.

The fluid 16 is a fluid whose temperature-viscosity correlation is known. The fluid 16 may be a fluid whose viscosity with respect to temperature is determined uniquely as illustrated in FIG. 2, and in general, the viscosity of a liquid decreases with increasing temperature and the viscosity of a gas increases with increasing temperature. This correlation can be measured using a commercially available viscometer. FIG. 2 illustrates as a curve 21 a viscosity change of a fluid with respect to temperature, when the temperature and the viscosity correspond to each other in one-to-one correspondence so that the viscosity of a certain fluid becomes ‘22’ at a particular temperature 23. Almost all the fluids show temperature dependency of viscosity, and hence the temperature measuring method of the present invention can be used for almost all the fluids in a range in which measurement can be performed with a commercially available viscometer.

### EXAMPLES

Hereinafter, the present invention is described in more detail with reference to exemplary examples. It should be noted that the following examples are for describing the present invention in more detail, and the embodiment is not limited to the following examples.

### Example 1

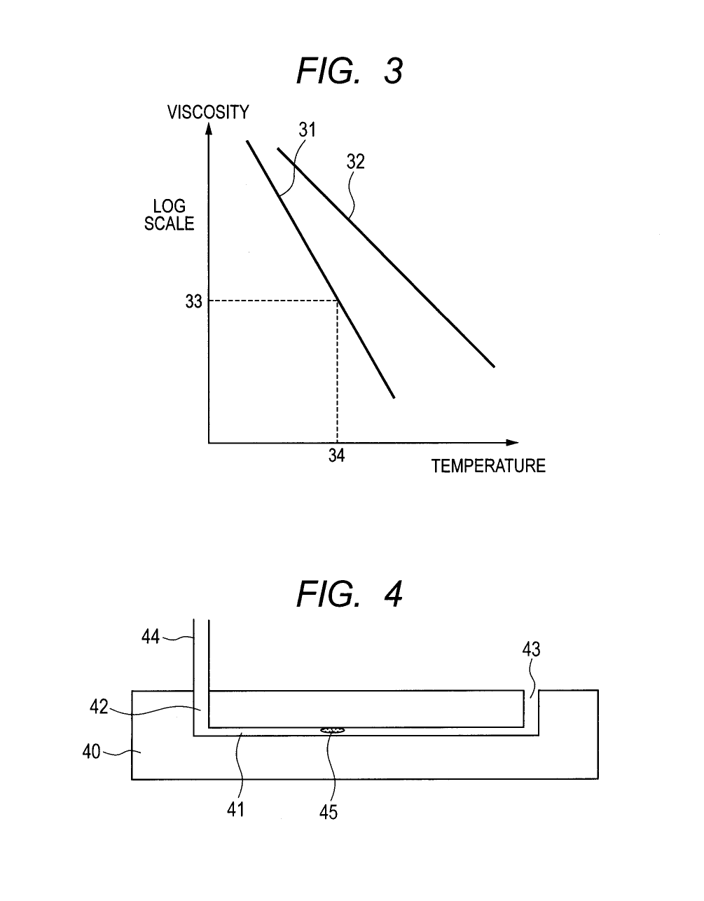

In Example 1, a method of measuring a temperature in a micro channel is described, using an oil whose temperature-viscosity correlation as illustrated in FIG. 3 is known, as the fluid 16 of FIG. 1.

The fluid 16 of FIG. 1 is assumed to have a temperature-viscosity correlation as illustrated in FIG. 3. Oil is known to have a large viscosity change with respect to a change in temperature as seen in engine oils for an automobile, and the index thereof is known as a viscosity index. Due to the difference in viscosity index, different temperature-viscosity correlations as represented by curves 31 and 32 can be obtained. Then, the relationship between the temperature and the viscosity is determined in one-to-one correspondence so that the viscosity is ‘33’ at a particular temperature 34.

In FIG. 1, the fluid 16 is pressurized by the syringe 15 and supplied to the micro channel 11 under a pressure measured by the pressure meter 14. On the other hand, the port 13 is opened to the atmosphere, and hence the pressure of the port 13 is the atmospheric pressure of the measurement environment, and the pressure difference between the port 13 and the port 12 is obtained. Further, the volume of flow is obtained by reading the scale on the syringe 15, and regarding the more detailed amount of flow, an amount of flow set by the syringe pump may be injected.

Further, the length, radius, or dimensions of the micro channel 11 are known at a time of producing the microfluidic device 10, and hence the viscosity can be calculated using the Hagen-Poiseuille equation. Further, in the Walther-ASTM equation, the coefficients m and n are determined in advance using the viscosities at 40° C. and 100° C. which are generally known. A temperature can be calculated by the Walther-ASTM equation from a value determined by converting the viscosity obtained from the coefficients m and n and the measured viscosity into a kinematic viscosity.

Now, it is assumed that an oil whose viscosity changes by about 5% with a change in temperature of 1° C. is injected to the micro channel 11. A high-precision viscometer has a precision of about 1%, and therefore the temperature-viscosity correlation is reliable with respect to a change in viscosity of 1%, which corresponds to a change in temperature of about 0.2° C. That is, a method of measuring a pressure change by injecting the above-mentioned oil into a micro channel has a temperature resolution of about 0.2° C. Further, oils having various viscosity indices can be prepared by mixing multiple kinds of oils, and hence a temperature can be measured with a desired temperature resolution.

In this way, the temperature in the micro channel can be measured by a simple apparatus without using optical measurement.

### Example 2

In Example 2, a temperature measuring method in the case where a fluid is not oil is described.

The fluid 16 of FIG. 1 is water and has a temperature-viscosity correlation as illustrated in FIG. 2. The correlation as illustrated in FIG. 2 can be measured with a resolution of about 1%, using a viscometer.

In FIG. 1, the fluid 16 is pressurized by the syringe 15 and supplied to the micro channel 11 under a pressure measured by the pressure meter 14. On the other hand, the port 13 is opened to the atmosphere, and hence the port 13 is under an atmospheric pressure of the measurement environment. In this case, the pressure difference between the port 12 and the port 13 is obtained. Further, the volume of flow is obtained by reading the scale on the syringe 15.

Further, the length, radius, or dimensions of the micro channel 11 are known at a time of producing the microfluidic device 10, and hence the viscosity can be calculated using the Hagen-Poiseuille equation. By collating the viscosity at this time with the correlation of the temperature measured previously, the temperature in the micro channel can be calculated.

In general, the viscosity of water in liquid state is 1.002 mPa·s (20° C.) and 0.3150 mPa·s (90° C.), and shows a change of about 70% at 70° C. In a range of 10° C. to 40° C. in which a change in viscosity is particularly large, it is considered that the viscosity of water changes by 1%/° C. or more. In this range, the viscosity can be measured within an error of about 1% with a high-precision viscometer, and hence the temperature in a channel can be measured within a range of 1° C. That is, when a reaction is performed within a range of 1° C. with a buffer in which water is the main component, it is possible to calibrate the temperature of a microfluid by using water in advance.

An example of the case where it is necessary to keep a micro channel in a range of about 1° C. includes cell culturing in a micro channel. Cell culturing is generally performed in a constant-temperature unit at a temperature of around 37° C. However, the temperature in the micro channel cannot be measured. Thus, using the method of the present invention, the temperature environment of a place where cell culturing is performed is measured, and the constant-temperature unit is set so as to be suitable for the culturing.

### Example 3

A method of measuring the temperature of a liquid droplet contained in a micro channel is described with reference to FIG. 4.

A microfluidic device 40 contains a micro channel 41, and the micro channel 41 communicates with the outside through ports 42 and 43. A tube 44 is connected to the port 42 and is further connected to a pressure meter and a syringe to supply a fluid to the micro channel 41. A liquid droplet 45 is composed of a component that is incompatible with the fluid.

The fluid is pressurized by the syringe to be supplied to the micro channel 41 under a pressure measured by the pressure meter. On the other hand, the port 43 is opened to the atmosphere, and hence the port 43 is under an atmospheric pressure of the measurement environment. Thus, a pressure difference between the port 43 and the port 42 is obtained. Further, the volume of flow is obtained by reading a scale on the syringe.

The length, radius, or dimensions of the micro channel 41 are known at a time of producing the microfluidic device 40, and hence the viscosity can be calculated using the Hagen-Poiseuille equation. Further, the temperature can be calculated by the Walther-ASTM equation or the temperature-viscosity correlation of a fluid measured previously.

For example, assuming that the liquid droplet 45 is water and a fluid surrounding the liquid droplet 45 is oil, the temperature of the liquid droplet 45 can be approximated to the temperature of oil. The volume of the liquid droplet only needs to be sufficiently smaller than the volume of the channel, and there is no particular limit thereto. An example using such a system includes an emulsion PCR, in which genes in the liquid droplet are amplified using a cycle of the set temperature region.

### Example 4

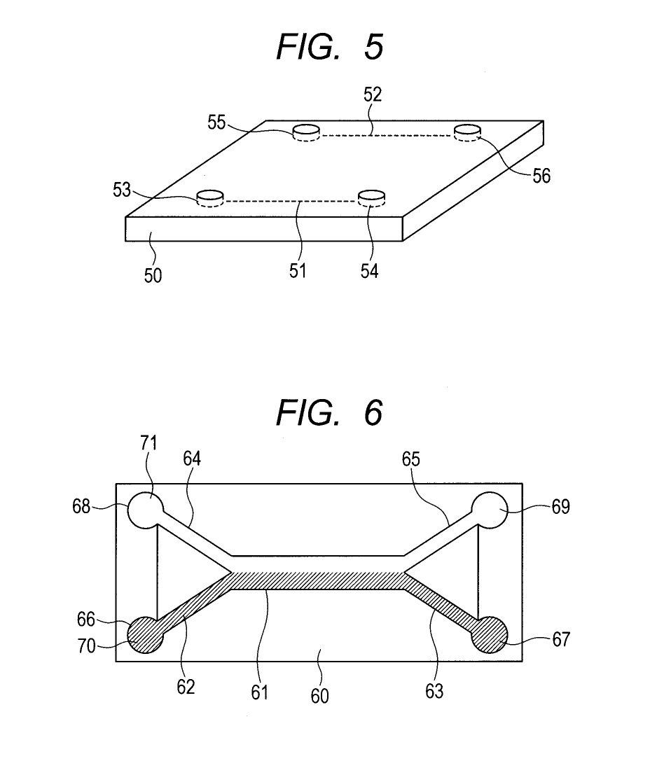

A method of easily measuring a surface temperature distribution in an arbitrary fluidic device is described with reference to FIG. 5. The temperature distribution of the surface of a semiconductor device can be measured with a radiation thermometer using infrared rays. However, in a fluidic device containing a channel, it is difficult to measure the temperature of the channel directly.

A microfluidic device 50 contains micro channels 51 and 52, and the micro channels 51 and 52 communicate with the outside through ports 53 and 54 and ports 55 and 56, respectively. The micro channels 51 and 52 are illustrated at positions close to both ends of the device as an example, but may be placed at any position.

The fluid is pressurized by a syringe to be supplied to the micro channels 51 and 52 under a pressure measured by the pressure meter. On the other hand, when the ports 54 and 56 are opened to the atmosphere, the ports 54 and 56 are under an atmospheric pressure of the measurement environment. Thus, pressure differences between the ports 53 and 54 and between the ports 55 and 56 are obtained. Further, the volume of flow is obtained by reading a scale on the syringe.

Further, the lengths, radii, or dimensions of the micro channels 51 and 52 are known at a time of producing the microfluidic device 50, and hence the viscosity of a fluid in each channel can be calculated. Finally, the temperature can be specified by the Walther-ASTM equation if the fluid is oil, or the temperature can be specified from the temperature-viscosity correlation if such correlation of a fluid is previously measured.

In this way, by using the temperature measuring method of the present invention, a surface distribution of a device temperature can be measured even for a device containing a channel.

### Example 5

A method of measuring the temperature of a fluid in a micro channel in real time is described with reference to FIG. 6.

FIG. 6 is a top view of a microfluidic device 60. The microfluidic device 60 includes a temperature measurement fluid 70, and the temperature measurement fluid 70 flows from a port 66 to a main channel 61 through an injection channel 62. On the other hand, a fluid 71 that is incompatible with the temperature measurement fluid 70 reaches the main channel 61 from a port 68 through an injection channel 64. In the main channel 61, the temperature measurement fluid 70 and the fluid 71 are merged, but keep laminar flows because the temperature measurement fluid 70 and the fluid 71 are incompatible with each other and have low Reynolds numbers. Further, in order to keep a more stable state of the laminar flows, a guide may be created on the bottom of the channel in the vicinity of the interface between the temperature measurement fluid 70 and the fluid 71. The temperature measurement fluid 70 and the fluid 71 are incompatible with each other and respectively flow into discharge channels 63 and 65 and flow to the outside of the microfluidic device 60 through ports 67 and 69.

Now, it is assumed that the temperature measurement fluid 70 is injected to the port 66 by a syringe at a predetermined amount of flow, and forms stable laminar flows with the fluid 71. If a pressure at the port 66 is measured, and the port 67 is opened to the atmosphere, a pressure difference between the ports 66 and 67 is obtained. The dimensions of the injection channel 62, the main channel 61, and the discharge channel 63 are known, and hence the viscosity of the temperature measurement fluid 70 can be calculated. The temperature is determined uniquely from the obtained viscosity of the temperature measurement fluid and the temperature-viscosity correlation.

The fluid 71 is in contact with the temperature measurement fluid 70 in the main channel 61. Therefore, it is considered that the temperature indicated by the temperature measurement fluid 70 is approximate to the temperature of the fluid 71. Specifically, if the temperature measurement fluid 70 is a mineral oil and the fluid 71 is an aqueous buffer solution, the temperature measurement fluid 70 and the fluid 71 are incompatible with each other to form laminar flows. Further, instead of directly measuring the temperature of the fluid 71 that is an aqueous buffer solution, the temperature measurement fluid 70 that is a mineral oil whose temperature dependency of the viscosity is higher than the buffer solution is observed, and hence temperature measurement with higher precision can be performed.

In this way, by using the temperature measuring method of the present invention, the temperature of a fluid in a micro channel can be measured while being in contact with the fluid without inhibiting the state of a flow of the fluid.

### INDUSTRIAL APPLICABILITY

The present invention is capable of measuring the temperature of a fluid in a micro channel, and hence can be used for measuring and calibrating the temperature in a microfluidic device or a capillary for conducting chemical synthesis, environment analysis, and clinical sample analysis.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-283382, filed Dec. 20, 2010, which is hereby incorporated by reference herein in its entirety.

1. A temperature measuring apparatus for a fluid in a micro channel, comprising:
a micro channel through which a fluid is allowed to flow;
a unit for measuring an amount of flow of the fluid;
a unit for measuring pressures at an inlet and an outlet of the micro channel; and
a unit for calculating a viscosity of the fluid and a temperature in the micro channel from a difference between the pressures.

2. A temperature measuring apparatus according to claim 1, wherein the fluid is previously measured for a temperature-viscosity correlation and is in a temperature range in which a relationship between a viscosity and a temperature is determined in one-to-one correspondence.

3. A temperature measuring apparatus according to claim 1, wherein the unit for measuring the amount of flow comprises one of a syringe, a syringe pump, and a flow sensor placed in one of inside and outside of the micro channel.

4. A temperature measuring apparatus according to claim 1, wherein the unit for measuring the pressures comprises a pressure sensor placed in one of inside and outside of the micro channel.

5. A temperature measuring apparatus according to claim 1, wherein the inlet and the outlet comprise ports that are placed on a surface of a microfluidic device including the micro channel and communicate with the micro channel, and a particular inlet and a particular output correspond to each other in one-to-one correspondence.

6. A temperature measuring apparatus according to claim 1, wherein the micro channel includes multiple injection channels for respectively injecting multiple fluids that are incompatible with one another, and is a channel in which the multiple injection channels are merged at one point on a downstream side of an injection point.

7. A temperature measuring method for a fluid in a micro channel, comprising:
measuring an amount of flow of a fluid flowing through the micro channel;
measuring pressures at an inlet and an outlet of the micro channel;
calculating a viscosity of the fluid; and
calculating a temperature in the micro channel.

8. A temperature measuring method according to claim 7, wherein a part of the micro channel contains a liquid droplet incompatible with the fluid.

9. A temperature measuring method according to claim 7, wherein, in the micro channel, multiple fluids incompatible with one another form laminar flows respectively, and a temperature of at least one of the laminar flows is measured.
